(19) United States
(12) Patent Application Publication
(10) Pub. No.: US 2024/0370814 A1
(43) Pub. Date: Nov. 7, 2024

(54) METHOD AND DEVICE FOR TRACKING AND CHECKING THE INTEGRITY OF GOODS SHIPMENTS

(71) Applicant: REP IP AG, Zug (CH)

(72) Inventors: Nico ROS, Riehen (CH); Stefan RETZKO, Zürich (CH)

(73) Assignee: REP IP AG, Zug (CH)

(21) Appl. No.: 18/573,299

(22) PCT Filed: Jun. 20, 2022
(86) PCT No.: PCT/IB2022/055704

§ 371 Date: Dec. 21, 2023

(30) Foreign Application Priority Data
Jun. 21, 2021 (AT) A 116/2021

(51) Int. Cl. G06Q 10/0832; G06Q 10/0833; G06T 7/73

(52) U.S. Cl. CPC G06Q 10/0832; G06Q 10/0833; G06T 7/74; G06T 2200/24

(57) ABSTRACT

In a method for tracking and for verifying the integrity of consignments of goods with a transport container which has a data logger for recording status data of the transport container and optionally a seal, the transport container being sent from a place of origin to a destination as part of a transport order, it is provided that at least a first digital image of the seal, of the transport container and/or of the goods arranged in the transport container is created at the place of origin and at the destination and that the digital images are compared by means of a comparison algorithm of a data processing unit in order to determine the extent to which the images match and in order to output as a result of the comparison algorithm whether the consignment of goods has remained intact or not.

### CROSS-REFERENCE TO RELATED APPLICATIONS

The present application is a national phase application of PCT Application No. PCT/IB2022/055704, filed Jun. 20, 2022, entitled “METHOD AND DEVICE FOR TRACKING AND CHECKING THE INTEGRITY OF GOODS SHIPMENTS”, which claims the benefit of Austrian Patent Application No. A 116/2021, filed Jun. 21, 2021, each of which is incorporated by reference in its entirety.

### BACKGROUND OF THE INVENTION

### 1. Field of the Invention

The invention relates to a method for tracking and verifying the integrity of consignments of goods with a transport container which has a data logger for recording status data of the transport container and optionally a seal, the transport container being sent from a place of origin to a destination as part of a transport order.

### 2. Description of the Related Art

The invention also relates to a device and a system for tracking and verifying the integrity of consignments of goods with a transport container.

When transporting goods in transport containers, such as air freight containers, the container can be equipped with a data logger. Data loggers are electronic devices that use built-in sensors to record data. They are generally small, battery-operated, portable and equipped with a microprocessor, an internal memory for data storage and sensors. Data loggers can be used with transport containers to track the geographical position of the container during its route and/or to record status data that may be critical to the cargo during transportation, such as temperature, humidity, etc.

Reading out the data makes it possible to track the geographical position of the container and the transportation conditions. There are known designs in which the data logger data is only read out at the destination, as well as designs that allow logger data to be transmitted during transportation.

When transporting temperature-sensitive goods, such as pharmaceuticals, over periods of several hours or days, specified temperature ranges must be maintained during storage and transportation in order to ensure the usability and safety of the transported goods. Temperature ranges of 2 to 25° C., in particular 2 to 8° C. or 15 to 25° C., are specified as storage and transportation conditions for various pharmaceuticals.

To ensure that the desired temperature range of the transported goods is permanently and verifiably maintained during transportation, transport containers, e.g., air freight containers, with special insulation properties are used. The technical implementation of temperature-controlled transport containers is usually carried out using active or passive cooling systems in combination with insulation of the outer shell.

In the case of temperature-sensitive goods, a data logger can be used to record the temperature in the transport container during transportation in order to assess whether the transported goods have been kept within a certain low temperature range. In general, data loggers can be used to verify the product temperature along a temperature-controlled supply chain.

In certain applications, however, additional verification mechanisms are required to prove the integrity of the transported goods. In the case of pharmaceutical shipments, for example, it should be ensured that the goods received by the recipient are the same goods as those sent by the sender. In particular, it should be possible to determine whether the transported goods were exchanged or part of them were stolen during transportation or whether the goods were opened. This type of inspection is time-consuming using conventional methods, as it usually requires manual inspection of the goods at the place of origin and destination. The documentation effort is also high because the condition, quantity and type of goods are recorded both at the place of origin and at the destination and recorded in suitable documentation systems, and the facts documented at the place of origin and at the destination must then be compared in a separate step in order to identify any discrepancies.

### SUMMARY OF THE INVENTION

The present invention is therefore based on the task of improving a method and a device for tracking consignments of goods in such a way that the integrity of the transported goods can be checked and documented with little effort and reliably, or irregularities can be detected quickly and reliably.

To solve this problem, the invention provides a method for tracking and verifying the integrity of consignments of goods, the consignment of goods being carried out using a transport container which has a data logger for recording status data of the transport container and optionally a seal, the transport container being sent from a place of origin to a destination as part of a transport order, the method comprising the following steps:
recording the geographical position of the transport container at the place of origin in order to obtain origin position data,
creating at least a first digital image of the seal, the transport container and/or the goods arranged in the transport container at the place of origin,
recording the geographical position of the transport container at the destination in order to obtain destination position data,
creating at least a second digital image of the seal, the transport container and/or the goods arranged in the transport container at the destination,
transmitting the origin position data, the destination position data, the at least one first digital image and the at least one second digital image to a data processing unit,
comparing the origin position data and the destination position data with the target values for the place of origin and the destination stored in the data processing unit and assigned to the transport order, and detecting any location deviation,
comparing the at least one first and the at least one second digital image of the seal and/or comparing the at least one first and the at least one second digital image of the goods and/or comparing the at least one first and the at least one second digital image of the transport container by means of a comparison algorithm of the data processing unit in order to determine the extent to which the images match,
outputting any location deviation, and
outputting the result of the comparison algorithm, in particular whether the consignment of goods has remained intact or not.

The invention is therefore based on the idea of using digital images to automatically check the integrity of the transported goods in addition to geographical tracking. It is therefore not necessary to carry out a separate and, in particular, manual analysis of the condition, quantity and type of goods. Instead, at least one digital image of the transport container seal, the transport container itself and/or the goods arranged in the transport container alone is used to determine whether tampering has taken place, whereby the check is carried out on the basis of the digital image without human intervention solely by an algorithm that is executed on a data processing unit.

The use of at least one digital image of the transport container seal at the place of origin and at the destination is particularly efficient and therefore preferred. The transport container seal is preferably attached to an opening mechanism of the transport container and is designed in such a way that it is irreversibly destroyed when the transport container is opened. If the transport container was opened on the way from the place of origin to the destination, the comparison algorithm recognizes that the seal is no longer intact based on changes in the image of the seal captured at the destination compared to the original image. Instead of attaching the seal to an opening mechanism of the transport container, the seal can also be designed as a sealing label, which can be attached to an opening point of a cardboard box, for example.

In order to be able to document the contents of the transport container and, in particular, to determine whether the contents at the destination correspond to those at the place of origin, the goods arranged in the transport container are preferably imaged and fed to the comparison algorithm. The digital image of the goods is preferably taken when the transport container is open, namely at the place of origin after the loading process has been completed and at the destination immediately after the transport container has been opened for the first time.

Alternatively or additionally, the exterior of the transport container at the place of origin and at the destination can also be imaged. This allows the image comparison to detect whether the transport container is externally intact or whether damage has occurred during transportation. This is helpful for documentation purposes if, for example, the causes of a prescribed temperature range for the internal temperature of the transport container not being adhered to are to be determined. Several digital images of the transport container can be created, in particular images of each of the four or six container walls.

The first and/or second digital image is preferably created using a digital camera, whereby in particular an integrated camera of a mobile telecommunications unit, such as a smartphone or the like, can be used.

The result of the comparison of the images carried out by the comparison algorithm is output in an appropriate manner, in particular as to whether the consignment of goods has remained intact or not. The result can preferably be output on a user interface of an electronic device which is controlled by the data processing unit or which connects to the data processing unit via a telecommunications network. The result can be output as a written message or in the form of a symbol or color.

The comparison algorithm can, for example, be designed in such a way that the integrity of the consignment is indicated if a predefined threshold value for the degree of matching of the first and second images is exceeded.

Preferably, however, the comparison algorithm is designed as a self-learning algorithm that does not necessarily work with fixed threshold values. The data processing unit provides a user interface on which the at least one first digital image and the at least one second digital image and the result of the comparison algorithm are displayed, wherein a user confirms or corrects the result of the comparison algorithm via the user interface, wherein the confirmation or correction is fed to the comparison algorithm in order to adapt the comparison algorithm. The self-learning algorithm can function according to the principle of an artificial neural network, for example, which can be optimized by training the network. In the learning phase, the result of the comparison algorithm is presented to the user as a suggestion, which the user must either confirm or correct, so that human intervention is still required to determine the integrity of the consignment. Once the learning phase is complete, the result of the comparison algorithm can be regarded as an autonomous decision on the (lack of) integrity of the consignment.

According to the invention, the comparison algorithm is executed by the data processing unit, i.e., where the captured position data and the digital images are merged. However, the term data processing unit is not to be understood as referring to a specific device. Rather, a data processing unit can also be formed by several computers, in particular servers, which are also distributed locally and interact via suitable interfaces and/or a computer network. The data processing unit according to the invention represents a central management instance in which the position data, the status data, the digital images and the like of the transport containers involved converge and are managed. This makes it possible to provide client devices with a central overview of past and current consignments.

According to a preferred embodiment of the method, the sender and the recipient of the consignment of goods are authenticated to ensure that the consignment reaches the right person. In this context, the preferred procedure is that a sender and a recipient are assigned to the consignment of goods in the data processing unit and that authentication means are provided to authenticate authorized users of the sender and the recipient using a mobile telecommunications unit. Preferably, the authentication means are arranged in the data processing unit and interact with the mobile telecommunications unit via a telecommunications link to authenticate a user as an authorized user of the sender or the recipient. For authentication via a mobile telecommunications unit, the data processing unit can provide a user interface, such as in particular a website, which a user can access via an application of the mobile telecommunications unit in order to perform user authentication, for example using a user name and a password and/or 2-factor authentication.

Preferably, it is provided that the creation of the at least one first or second digital image of the seal, the transport container and/or the goods arranged in the transport container takes place at the place of origin or at the destination using the mobile telecommunications unit via which, and preferably after, the user has been authenticated as an authorized user of the sender or the recipient. This ensures that the user who takes the respective digital image and subsequently transmits it to the data processing unit is the authenticated user.

For particularly high security, it is possible to proceed in such a way that the at least one first or second digital image is cryptographically linked to a user identification of the authorized user, preferably by the mobile telecommunications unit. In this way, the image data can be inseparably linked to the user identification of the user who created the respective image. The linked data is transmitted to the data processing unit, where the transmitted data can be checked to see whether it has been changed or manipulated during transmission.

The geographical position of the transport container at the place of origin and/or destination can be recorded by means of a mobile telecommunications unit separate from the transport container, preferably the same mobile telecommunications unit that is used for user authentication and/or recording the digital image. In this case, the mobile telecommunications unit can transmit the position data to the data processing unit. Alternatively, the geographical position of the transport container can be recorded by the data logger at the place of origin and/or destination. For this purpose, the data logger or the mobile telecommunications unit is equipped with a receiver for a global navigation satellite system, such as GPS.

If the geographical position of the transport container at the place of origin and/or destination is recorded by the data logger, the origin position data and the destination position data can be transmitted from the data logger to the data processing unit. The transmission of the origin position data or the destination position data can take place via a low-power network (LPN) system. Among the various LPN platforms and technologies, the LoRa system (Long Range) is preferred. LoRa is a low-power wide-area network technology based on spread-spectrum modulation techniques derived from the chirp spread spectrum.

Alternatively, the origin position data at the place of origin and/or the destination position data at the destination can each be read from the data logger by a fixed or mobile telecommunications unit and transmitted from the telecommunications unit to the data processing unit. If a mobile telecommunications unit is used for reading the data logger, it is preferably the same mobile telecommunications unit that is used for user authentication and/or recording the digital image. If a stationary telecommunications unit is used, it can, for example, be designed as a gateway, i.e. a stationary station within a logistics network, past which transport containers are guided in order to exchange data with a built-in data logger of the transport container via near-field communication.

As already mentioned, when transporting temperature-sensitive goods, such as medicines or vaccines, it is necessary to monitor the temperature and other environmental conditions in order to detect any deviations or to document compliance with the prescribed temperature ranges. In this context, a preferred embodiment of the invention provides that the data logger records status data several times during the consignment of goods, such as the internal temperature of the transport container and possibly the ambient temperature of the transport container, and in that the status data are transmitted from the data logger to the data processing unit or are read out from the data logger at the place of origin and/or at the destination in each case by a fixed or mobile telecommunications unit and are transmitted from the telecommunications unit to the data processing unit. Here too, if a mobile telecommunications unit is used to read out the data logger, it is preferably the same mobile telecommunications unit that is used to authenticate the user and/or record the digital image. If a stationary telecommunications unit is used, this can be designed as a gateway, for example.

The recorded status data is preferably evaluated in the data processing unit. The preferred procedure for this is that a target range of the internal temperature of the transport container is assigned to the consignment of goods, in that the data processing unit compares whether the temperature data recorded by the data logger are within the target range, and in that the result of the comparison is output as whether or not the consignment of goods has remained within the target range.

In principle, the transport container can be of any design, e.g., as a transport container, air freight container, transport box, cardboard box and the like.

The transport container preferably comprises thermal insulation which encloses the interior of the container holding the goods on all sides in order to ensure that a prescribed temperature range is maintained in the container interior for at least 48 hours, even at an ambient temperature which is 10° C. above or below the temperature range. The thermal insulation can include an insulating cover. The thermal insulation can include heat-reflecting layers, such as container walls with a metallic coating. The thermal insulation can include latent heat storage elements. The thermal insulation can comprise at least one air gap that surrounds the interior on all sides. Combinations of the insulation options mentioned are conceivable.

According to a further aspect of the invention, a device for tracking and verifying the integrity of consignments of goods with a transport container is provided, which is particularly suitable for carrying out the method according to the invention. The device comprises an electronic data processing unit which has stored data associated with a transport order, comprising an place of origin and a destination, the electronic data processing unit having a data interface for receiving data, via which origin position data and destination position data of a transport container and at least a first digital image of a seal of the transport container, the transport container and/or the goods arranged in the transport container at the place of origin and at least a second digital image of the seal of the transport container, the transport container and/or the goods arranged in the transport container at the destination are received, wherein the data processing unit comprises location comparison means for comparing the origin position data and the destination position data with target values for the place of origin and the destination stored in the data processing unit and assigned to the transport order and for detecting any location deviation, wherein the data processing unit comprises means for executing a comparison algorithm, with which the at least one first and the at least one second digital image of the seal and/or the at least one first and the at least one second digital image of the goods and/or the at least one first and the at least one second digital image of the transport container are compared in order to determine the extent to which the images match, and wherein the data processing unit comprises means for generating a user interface on which any location deviation and, as a result of the comparison algorithm, whether or not the consignment of goods has remained intact are output.

Preferably, the comparison algorithm is designed as a self-learning algorithm and interacts with the user interface to display on the user interface the at least one first digital image and the at least one second digital image and the result of the comparison algorithm, and to enable a user to confirm or correct the result of the comparison algorithm via the user interface, wherein the confirmation or correction is fed to the comparison algorithm to adjust the comparison algorithm.

Preferably, the stored data associated with the transport order comprises a sender and a recipient of the consignment of goods, wherein the data processing unit comprises authentication means for authenticating authorized users of the sender and the recipient using a mobile telecommunications unit, wherein the authentication means are adapted to cooperate with the mobile telecommunications unit via a telecommunications link to authenticate a user as an authorized user of the sender and the recipient, respectively.

Preferably, the data processing unit is designed to read out a user identification of an authorized user of the sender or recipient from the at least one first or second digital image and to compare it with the stored sender or recipient.

A further preferred embodiment provides that the stored data associated with the transport order comprises a target range of the internal temperature of the transport container, and that the data processing unit comprises comparison means for determining whether temperature data detected by a data logger of the transport container and received via the data interface is within the target range, and that the comparison means cooperates with the user interface to output as a result of the comparison whether or not the consignment of goods has remained within the target range.

A further aspect of the invention relates to a system for tracking and verifying the integrity of consignments of goods with a transport container, comprising an electronic data processing unit according to the second aspect of the invention, at least one transport container provided with a seal and equipped with a data logger, and a mobile telecommunications unit, wherein the system is designed to carry out the method according to the invention.

### BRIEF DESCRIPTION OF THE DRAWINGS

The invention is explained in more detail below with reference to an exemplary embodiment shown schematically in the drawing. Therein,

FIG. 1 shows a block diagram of a system suitable for carrying out the method according to the invention and

FIG. 2 is an exemplary graphical representation of the results of an automatic evaluation of the transport-relevant data.

### DETAILED DESCRIPTION

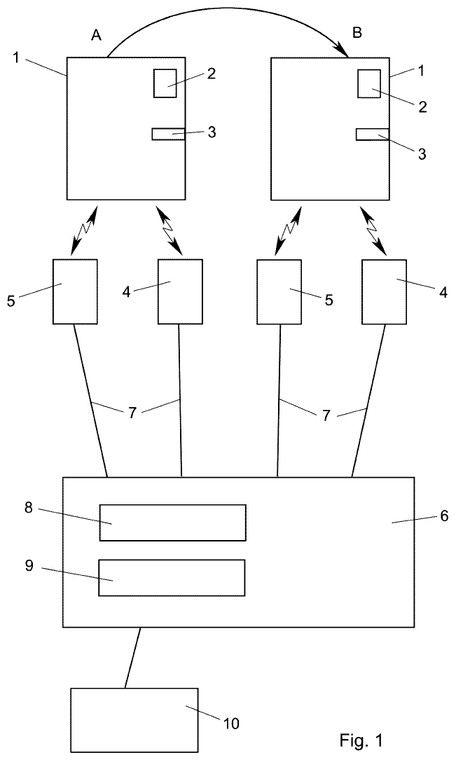

FIG. 1 schematically shows a transport container 1 that is to be transported from a place of origin A to a destination B, e.g., by air freight. The transport container 1 comprises thermal insulation to keep the transported goods within a temperature range of, for example, 2 to 8° C., 15 to 25° C., −15 to −30° C. or −60 to −80° C. The transport container 1 is preferably designed as a freight container and preferably has external dimensions of >1500×1300×1500 mm. The transport container 1 is equipped with a data logger 2, which has a GPS receiver and is able to measure and record the temperature in the interior of the transport container 1 and the ambient temperature of the transport container 1. The transport container 1 also includes an opening option, such as a door (not shown) in the case of a container, which can be secured with a seal 3. The seal 3 is designed in such a way that it is irreversibly damaged when the transport container is opened.

FIG. 1 also shows a stationary gateway 4, which is designed to identify the transport container, e.g., by means of a printed or electronically readable identifier, and to communicate with the data logger 2 via short-range communication in order to read out the data logger 2. Furthermore, a mobile telecommunications unit 5 is provided, which is equipped with a camera in order to record and at least temporarily store at least one digital image of the seal 3, the transport container 1 and/or, when the transport container 1 is open, of the goods arranged therein. Furthermore, the mobile telecommunications unit 5 can be used as an alternative to the gateway 4 to communicate with the data logger 2 via short-range communication in order to read out the data logger 2. The mobile telecommunications unit 5 can be designed as a smartphone or tablet, for example.

The gateway 4 and the mobile telecommunications unit 5 comprise a telecommunications module which enables them to establish data communication with a central data processing unit 6. The data read from the data logger 2 together with an identification of the transport container 1 can be transmitted to the data processing unit 6 via the data connection 7. Furthermore, the at least one digital image recorded by the mobile telecommunications unit 5 can be transmitted to the data processing unit 6 in this way. Before transmitting data from the mobile telecommunications unit 5 to the data processing unit 6, a user authenticates himself to the data processing unit 6 by means of an authentication function of the mobile telecommunications unit 5.

The following data is collected and made available to the data processing unit 6 as part of the processing of a transport order:
at the place of origin:
   the geographical position of the transport container 1
   at least one digital image of the seal after the transport container has been filled, closed and sealed
   optional: at least one digital image of the transport container 1 from the outside, e.g. of the side walls,
   optional: at least one digital image of the goods arranged in the transport container when the container is open
during transportation (several times or continuously):
   temperature measurement data
   optional: the geographical position
at the destination:
   the geographical position of the transport container 1
   at least one digital image of the seal before the transport container is opened
   optional: at least one digital image of the transport container 1 from the outside, e.g. of the side walls,
   optional: at least one digital image of the goods arranged in the transport container when the container is open

A transport container identifier is assigned to all the data mentioned, which identifies the respective transport container. If the data was recorded via the mobile telecommunications unit 5, the authenticated user is also assigned to the data.

For each transport order, the data processing unit 6 has stored target values 8 for the geographical position of the place of origin and destination and for a permissible temperature range for the inside temperature of the transport container. Furthermore, the actual data 9 is available for each transport order so that a comparison can be made. The comparison makes it possible to check whether the transport container has traveled from the place of origin to the destination, whether the prescribed temperature range has been maintained, whether an authorized user has dispatched or received the goods and whether the goods have remained intact. The latter is carried out in the data processing unit 6 using a comparison algorithm that compares the digital images received from the place of origin and the destination.

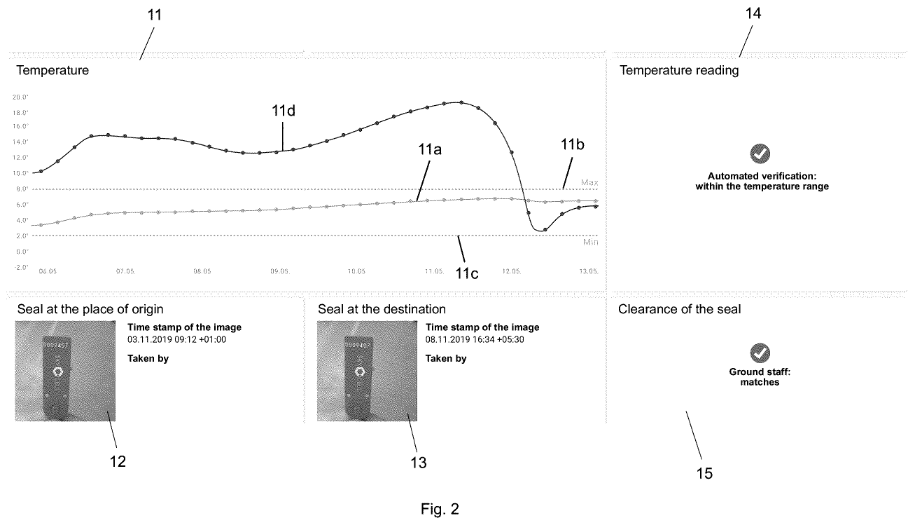

The data processing unit 6 can provide a user interface 10 which graphically displays the result of the above-mentioned comparison, as shown in FIG. 2 as an example. The user interface comprises an area 11 in which the course of the temperature 11a measured in the interior of the transport container 1 is shown in comparison to the maximum 11b and the minimum 11c of the prescribed temperature range and also the course of the ambient temperature 11d. Based on this data, the data processing unit 6 can automatically determine whether the prescribed temperature range has been maintained and display a corresponding positive result in area 14.

In areas 12 and 13, the user is shown a digital image of the seal 3 taken at the place of origin or a digital image of the seal 3 taken at the destination, so that the user can understand, check and, if necessary, correct/confirm the information about the integrity of the consignment of goods displayed by the comparison algorithm in area 15.

1-16. (canceled)

17. A method for tracking and for verifying an integrity of a consignment of goods with a transport container which has a data logger for recording status data of the transport container, the transport container being dispatched from a place of origin to a destination as part of a transport order, comprising the following steps:
recording a first geographical position of the transport container at the place of origin in order to obtain origin position data;
creating at least a first digital image of at least one of a seal, the transport container, and the goods arranged in the transport container at the place of origin;
recording a second geographical position of the transport container at the destination in order to obtain destination position data;
creating at least a second digital image of at least one of the seal, the transport container, and the goods arranged in the transport container at the destination;
transmitting the origin position data, the destination position data, the at least one first digital image, and the at least one second digital image to a data processing unit;
comparing the origin position data and the destination position data with target values for the place of origin and the destination stored in the data processing unit and assigned to the transport order, and detecting any location deviation;
comparing, by a comparison algorithm of the data processing unit to determine an extent to which images match, at least one of:
the at least one first digital image of the seal and the at least one second digital image of the seal,
the at least one first digital image of the goods and the at least one second digital image of the goods; and
the at least one first digital image of the transport container and the at least one second digital image of the transport container;
outputting any location deviation; and
outputting a result of the comparison algorithm.

18. The method according to claim 17, wherein:
the comparison algorithm is a self-learning algorithm;
the data processing unit provides a user interface on which the at least one first digital image and the at least one second digital image and the result of the comparison algorithm are displayed;
a user confirms or corrects the result of the comparison algorithm via the user interface; and
the confirmation or correction is fed to the comparison algorithm in order to adapt the comparison algorithm.

19. The method according to claim 17, wherein:
a sender and a recipient are assigned to the consignment of goods in the data processing unit; and
authentication means are provided to authenticate an authorized user of the sender and the recipient using a mobile telecommunications unit.

20. The method according to claim 19, wherein the mobile telecommunications unit is used to create one of the at least one first digital image and the at least one second digital image.

21. The method according to claim 20, wherein the one of the at least one first digital image and the at least one second digital image is cryptographically linked to a user identification of the authorized user.

22. The method according to claim 17, wherein at least one of the first geographical position and the second geographical position is recorded by a mobile telecommunications unit separate from the transport container or by the data logger.

23. The method according to claim 22, wherein the origin position data and the destination position data are transmitted from the data logger to the data processing unit.

24. The method according to claim 22, wherein at least one of the origin position data and the destination position data are read out from the data logger by a fixed telecommunications unit or the mobile telecommunications unit and transmitted to the data processing unit.

25. The method according to claim 17, wherein:
the data logger records the status data a plurality of times during the consignment of goods;
the status data are one of transmitted from the data logger to the data processing unit and read out from the data logger at at least one of the place of origin and at the destination by a fixed telecommunications unit or a mobile telecommunications unit and are transmitted to the data processing unit.

26. The method according to claim 25, wherein:
a target range of the internal temperature of the transport container is assigned to the consignment of goods;
the data processing unit compares whether the temperature data recorded by the data logger are within the target range; and
the result of the comparison is output as whether or not the consignment of goods has remained within the target range.

27. A device for tracking and verifying the integrity of consignments of goods with a transport container, comprising:
an electronic data processing unit storing data associated with a transport order, the data including a place of origin and a destination; and
a data interface for receiving data, via which origin position data and destination position data of a transport container and at least a first digital image of at least one of a seal of the transport container, the transport container, and the goods arranged in the transport container at the place of origin and at least a second digital image of at least one of the seal of the transport container, the transport container, and the goods arranged in the transport container at the destination are received;
wherein the data processing unit comprises location comparison means for comparing the origin position data and the destination position data with target values for the place of origin and the destination stored in the data processing unit and assigned to the transport order and for detecting a location deviation;
wherein the data processing unit comprises means for executing a comparison algorithm, the comparison algorithm configured to compare the at least one first digital image and the at least one second digital image to determine an extent to which the images match; and
wherein the data processing unit is configured to generate a user interface to output the location deviation and a result of the comparison algorithm determining if the consignment of goods remains intact.

28. The device according to claim 27, wherein the comparison algorithm is a self-learning algorithm that cooperates with the user interface to display on the user interface the at least one first digital image, the at least one second digital image, and the result of the comparison algorithm, and enables the user to confirm or correct the result of the comparison algorithm via the user interface, the confirmation or the correction being fed to the comparison algorithm to adapt the comparison algorithm.

29. The device according to claim 27, wherein:
the stored data associated with the transport order comprises a sender and a recipient of the consignment of goods; and
the data processing unit comprises an authentication arrangement for authenticating authorized users of the sender and the recipient using a mobile telecommunications unit, the authentication arrangement being adapted to cooperate with the mobile telecommunications unit via a telecommunications link to authenticate the user as an authorized user of the sender and the recipient, respectively.

30. The device according to claim 29, wherein the data processing unit reads out a user identification of an authorized user of the sender or the recipient from the at least one first digital image or the at least one second digital image, and to compares the user identification with the sender or the recipient.

31. The device according to claim 27, wherein:
the stored data associated with the transport order comprises a target range of the internal temperature of the transport container;
the data processing unit comprises a comparison arrangement for determining whether temperature data detected by a data logger of the transport container and received via the data interface is within the target range; and
the comparison arrangement cooperates with the user interface to output as a result of the comparison whether or not the consignment of goods has remained within the target range.

32. A system for tracking and verifying the integrity of consignments of goods with a transport container, comprising:
an electronic data processing unit storing data associated with a transport order, the data including a place of origin and a destination; and
a data interface for receiving data, via which origin position data and destination position data of a transport container and at least a first digital image of at least one of a seal of the transport container, the transport container, and the goods arranged in the transport container at the place of origin and at least a second digital image of at least one of the seal of the transport container, the transport container, and the goods arranged in the transport container at the destination are received;
at least one transport container provided with a seal and equipped with a data logger; and
a mobile telecommunications unit;
wherein the data processing unit comprises location comparison means for comparing the origin position data and the destination position data with target values for the place of origin and the destination stored in the data processing unit and assigned to the transport order and for detecting a location deviation;
wherein the data processing unit comprises means for executing a comparison algorithm, the comparison algorithm configured to compare the at least one first digital image and the at least one second digital image to determine an extent to which the images match; and
wherein the data processing unit is configured to generate a user interface to output the location deviation and a result of the comparison algorithm determining if the consignment of goods remains intact.
